(19) United States
(12) Patent Application Publication
(10) Pub. No.: US 2018/0185209 A1
(43) Pub. Date: Jul. 5, 2018

(54) Modulable sports wheelchair

(71) Applicant: Universitá degli Studi di Bergamo, Bergamo (IT)

(72) Inventors: Simone Fontanesi, Seriate (BG) (IT); Michele Bombardieri, Albino (BG) (IT); Mario Poletti, Villa D'Ogna (BG) (IT)

(21) Appl. No.: 15/739,764

(22) PCT Filed: Sep. 1, 2016
(86) PCT No.: PCT/IB2016/055237

§ 371 Date: Dec. 25, 2017

(30) Foreign Application Priority Data
Sep. 2, 2015 (IT) 102015000048007

(51) Int. Cl. A61G 5/02; A61G 5/10

(52) U.S. Cl. CPC A61G 5/021; A61G 5/12; A61G 5/1005; A61G 5/1056

(57) ABSTRACT

A modulable sports wheelchair includes a supporting frame, a front wheel, a pair of rear wheels and a sitting cage. The supporting frame is divided into a front half-frame connecting a support for the front wheel with a frame structure carrying the rear wheels. The frame structure has at least two longitudinal sides oriented in the movement direction of the wheelchair and two transverse sides spaced and oriented in the other direction so as to form the cage, which takes the shape of a compartment free from internal structural elements and is adapted to receive an athlete with an optimal position for propelling the wheelchair depending on the level and type of disability of the athlete.

The present invention relates to the field of wheelchairs for disabled athletes and it relates to a wheelchair according to the preamble of claim 1.

Wheelchairs for athletics are currently customized for each athlete depending on the type of disability and on his/her body size. This involves high acquisition costs and high differentiation level of the product.

For this reason a person that desires to try wheelchair racing unlikely is able to find a device tailored to his/her needs unless requiring a customized device and incurring the high costs it involves.

This situation leads to the fact that fewer and fewer people are approaching athletics, preventing such sport from developing and wide spreading.

Currently the market provides customized and high-cost solutions (for example Top End® EliminatorTM OSR Racing Wheelchair by Invacare Corp) or low-cost solutions manufactured in sizes (for example Flying Start wheelchair by Motivation Direct ltd.).

Even in the cases when a mass production with different sizes is provided, wheelchairs do not fully meet modulability requirement and the requirement of being tailored to the needs of each user.

This is particularly important when referring to sports wheelchairs for race competitions. In this case, the position of the athlete and the points of contact between him/her and the frame of the wheelchair, as well as the transfer of the push force exerted by the arms, have to be optimized to avoid dissipating a part of the effort in stresses that are not functional for propelling the wheelchair.

The document US2009/194974 describes a conventional wheelchair wherein the frame thereof is composed of two side elements of the frame longitudinally and vertically extending and connected by transverse elements of the frame. The transverse elements of the frame are composed of two parts each one integral with a side element of the frame and said two parts can be fitted into each other and are axially slidable in an extending and shortening direction, that is in a direction moving the two side elements of the frame away and near each other. There are further provided locking means that lock in position the two parts forming a transverse element of the frame. In the document US2009/194974 each transverse element of the frame can take only two positions, a final extended position and a final shortened position, which correspond to a collapsed condition of the wheelchair for being transported or parked and a condition for using it. The document does not provide in the shown embodiment and in the described variants to progressively adjust, both in a continuous manner and by steps, the length of the transverse elements, and it does not allow the two transverse element parts to be locked in a relative position different from the provided positions of maximum extension or minimum shortening.

The document US2001/0011805 describes a wheelchair for disabled people having transverse elements of predetermined and fixed length. The structure of the frame allows some adjustments of the frame geometry and particularly of the seat position with respect to propelling wheels.

The document US2012/0169026 describes a wheelchair wherein two side elements of the frame are connected to each other by transverse elements of predetermined and non-variable length.

The above is valid also for the document DE202014002843U where the side elements of the frame allow the geometry of the frame to be adjusted as regards the seat position, seat inclination and other adjustments. However the transverse elements of the frame have a fixed length and do not allow the wheelchair to be width adjusted.

The document WO2008/044541 describes a wheelchair foldable in the transverse direction from a position of non-use wherein the two side elements of the frame are moved one towards the other one to a position of use wherein the two frame elements are moved away from each other at a fixed and not adjustable distance. The connection of the side elements of the frame occurs by means of two arms crossed and pivoted with each other at the central point and with their respective ends pivoted to elements sliding on vertical rods of respective side elements of the frame. The described structure does not allow the width of the wheelchair to be adjusted progressively or by steps and such priority is not provided or described.

The document US20060244227 describes a wheelchair with an alternative system for supporting the wheel. The frame comprises transverse elements with fixed and not adjustable length. Moreover the frame is configured so as not to be able to be modified also as regards the side elements thereof.

Moreover no document according to the prior art describes or shows a wheelchair frame, particularly but not exclusively for competitions, that allows a support of the user to be positioned in a variable manner and that in combination with the configuration of the frame allows the user to take the best position depending on the type of his/her disability.

The aim of the present invention is to provide a modulable wheelchair that can be tailored to anthropometric dimensions and to disabilities of the user such to allow anyone to approach athletics without the need of acquiring a customized model thus facilitating, through sports, the social integration of people suffering from disabilities.

The invention achieves the aim by providing a modulable sports wheelchair having the characteristics of the preamble of claim 1 and comprising in combination the characteristics of the characterizing part of claim 1.

By the use of a structural seating cage, that is weight-bearing cage, it is not more necessary to use central rods supporting the rear wheels as in prior art solutions. This allows the part underneath the cage to be set free from any type of frame element that can interfere with the user body thus maximizing the space available for the athlete guaranteeing the highest flexibility in positioning, a particularly important aspect since it is strictly related to the type of disability.

According to a further advantageous characteristic, the wheelchair frame is adjustable in width direction, that is according to an axis perpendicular to the forward direction in a progressive manner and with a continuous change or by steps it being further removably lockable in any of the width adjustment conditions.

Such characteristic can be obtained by several constructional characteristics.

One embodiment provides the side, longitudinal elements of the frame to be free to translate continuously or by steps in a direction moving them away and near each other and are removably lockable with respect to each other, said side longitudinal elements of the frame being slidable on at least one (2) of the connection transverse rods and/or at least one (5, 7) of the connection transverse rods being extendable and shortenable such to allow the width of the cage to be progressively changed depending on the size of the athlete.

According to a further characteristic, the front half-frame (1) can be connected to at least one of these rods.

The removable locking means can be composed of radial pegs engaging into corresponding holes of rows of axial holes provided on at least one of two telescopic segments composing each transverse element of the frame.

As an alternative two side elements of the frame have bushings or sleeves or transverse tubular segments mounted so as to slide axially along transverse connecting rods each sleeve being provided with means tightening against the transverse rod on which it is mounted.

Examples of such tightening means can be radial threaded pins rotatably engaged in a radial threaded hole provided on each transverse sleeve and whose screwing generates a radial force tightening the rod on which the sleeve is fitted.

As an alternative said tightening means can be composed of tightening clamps or rings adjustable as regards their diameter and that are fitted on end portions of the sleeves which portions are provided with an axial notch or an axial slot open at one end and whose walls are tightened against the shell surface of the rod on which the sleeves are fitted by means of said tightening rings or said clamps.

Therefore by means of its particular arrangement, according to which the frame structure can be divided into two parts free to translate on transverse connecting rods such to allow the cage width to be adjusted depending on the athlete size, it is immediately clear how it is possible to meet the needs of a great number of users by means of a single means, thus allowing sports associations to provide a easy access to athletics for anyone desiring it.

Further arrangements allow modulability and configurability of the wheelchair of the invention to be enhanced.

According to an advantageous embodiment the side elements of the frame structure comprise a fastening element provided with a plurality of holes arranged according to at least two directions such to allow rear wheels to be removably mounted at a variable distance, both along the direction of the longitudinal sides and in height direction. This allows the position of the attachment of the rear wheels to be adjusted with respect to the cage increasing the flexibility of use thereof. Even the position and dimensions of the pushrims on which the athlete act to move the wheelchair can be changed to suit the several needs.

In order to reduce costs wheels are preferably of the spoke type with pushrims provided to be mounted on plates inserted between the wheel spokes and fastened thereto by means of screw tightening means such to reduce the attachment points of the pushrims for mounting/removing them more easily.

The dimensions of the pushrims, of rear wheels and their position with respect to the cage are typically selected such to allow the athlete to take an optimal position for his/her disability on a seat arranged inside the cage and composed of a strap fastened, in an adjustable manner, by each end to one of two facing side longitudinal elements of the frame.

Specifically the optimal position for a paraplegic athlete is a position kneeling inside the cage with the trunk leant forwards. In this case the pushrims and rear wheels are selected with such a dimension, shape and position with respect to the cage that the vertical line passing by the shoulder of the athlete with the trunk parallel to the ground and arm extended on the pushrim is tangent to the corresponding wheel.

In case of a tetraplegic athlete the optimal position on the contrary is a position seating in the cage with feet forward. In this case the pushrims and rear wheels are selected with such a dimension, shape and position with respect to the cage that the vertical line passing by the shoulder of the athlete has always a distance from the center of the pushrim greater than the radius thereof.

Advantageously the cage comprises a backrest supported by straps fastenable in an adjustable manner on opposite sides of the frame structure to move the seat of the athlete forward or rearward without acting on the cage structure.

Side, longitudinal elements of the frame structure extend in a substantially vertical plane.

According to an advantageous characteristic said elements comprise curved rods shaped such to join the extreme positions taken by the rear wheels. Specifically the curved rods follow the profile of the wheelhouses integral thereto that prevent the athlete from interfering with the wheel tread.

Side, longitudinal elements of the frame structure are composed of rods for example for supporting the seat and supporting the backrest, that advantageously are coplanar to reduce manufacturing complexity and the efforts. A structural analysis has made it possible to verify that the presence of out-of-plane nodes results in bad torques stressing the structure to a greater extent. Specifically the frame structure comprises two rod longitudinal side structures forming trusses connected through at least one pair of sliding transverse rods one of which, with elliptical section, being connected to the half-frame bearing the front wheel.

The structure is completed with a pair of supports, mounted on the frame by means of ring fastening elements adjustable as regards the position and inclination such to laterally hold the athlete knees. The adjustable supports advantageously comprise a system of rods arranged such to form an articulated quadrilateral such to allow their inclination to be changed while modifying the mutual position of the frame fastening rings.

According to another aspect the invention relates to a cheap, lightweight and highly reconfigurable roller device to be used by athletes for pre-race warmup.

The high configurability is essentially due to the provision of independent hinges for each roller support associated to feet adjustable by means of holes to change the inclination of rollers such to guarantee the wheelchair to be contained at the sides and it is due to the possibility of changing the width of the rollers, preventing it from laterally deviate due to the push action.

Further characteristics and improvements are the subject matter of the sub claims.

Characteristics of the invention and advantages deriving therefrom will be more clear from the following detailed description of the annexed figures wherein:

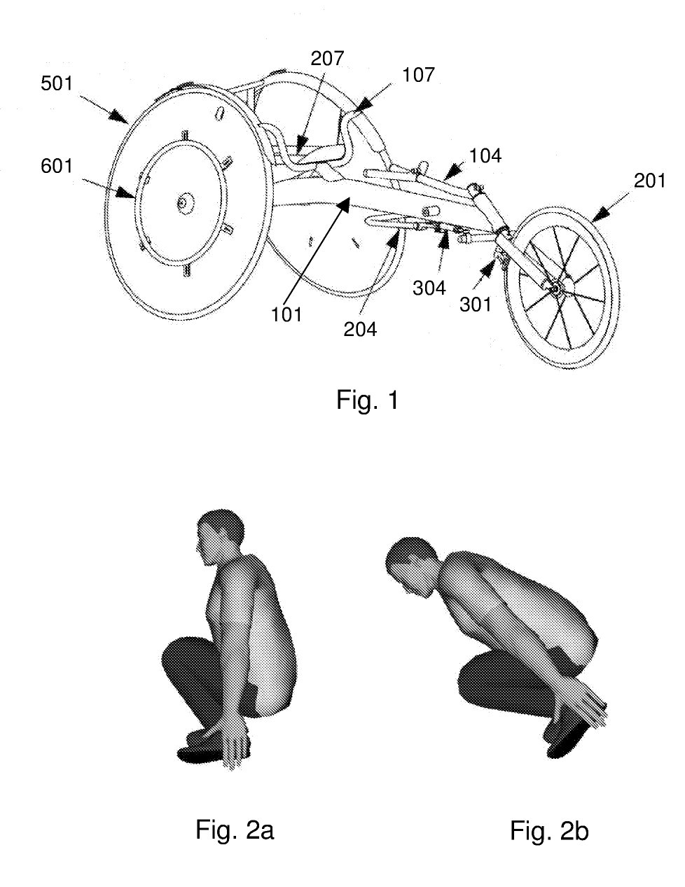

FIG. 1 is a wheelchair for athletics according to prior art.

FIG. 2 is the positions taken by a tetraplegic athlete (FIG. 2a) and paraplegic athlete (FIG. 2b).

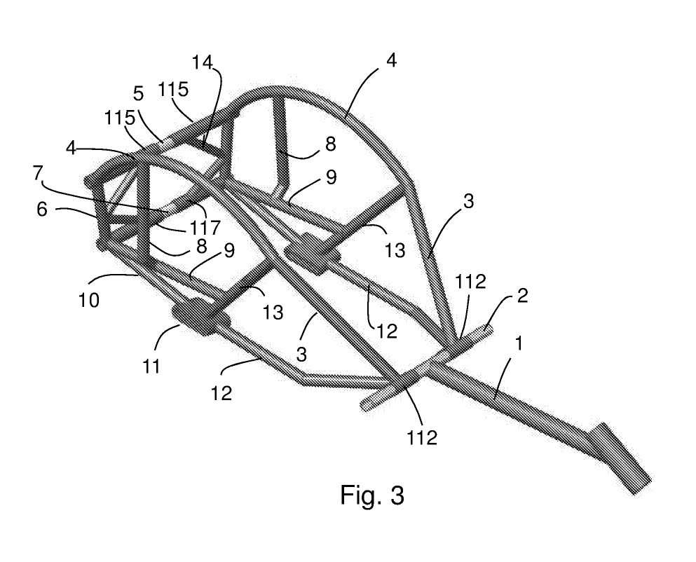

FIG. 3 is an axonometric view of the frame of a wheelchair according to a first embodiment of the invention.

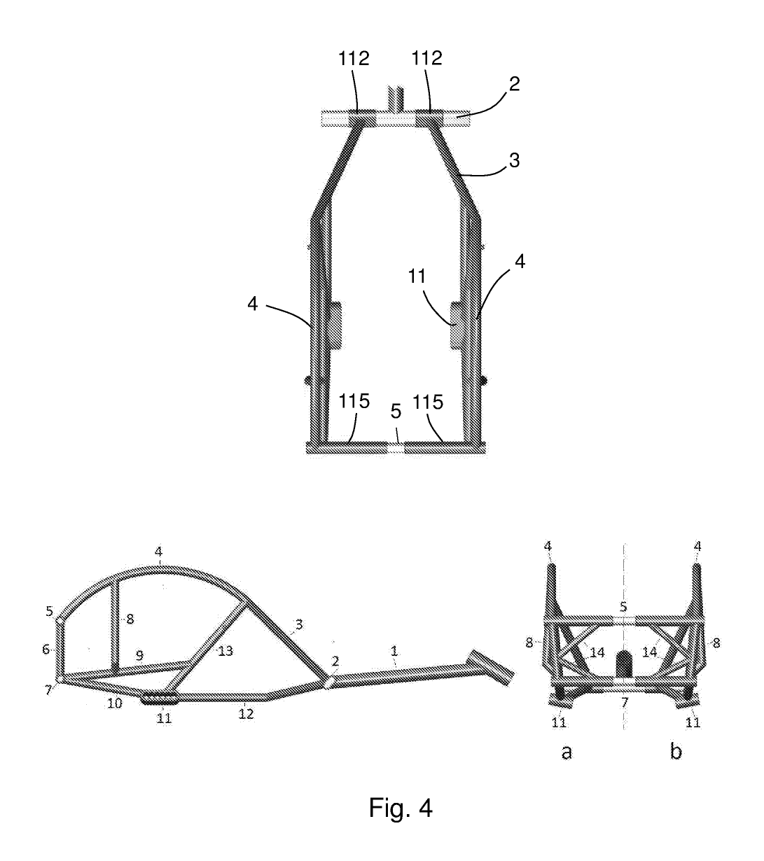

FIG. 4 is a top, side and rear view of the frame of the previous figure.

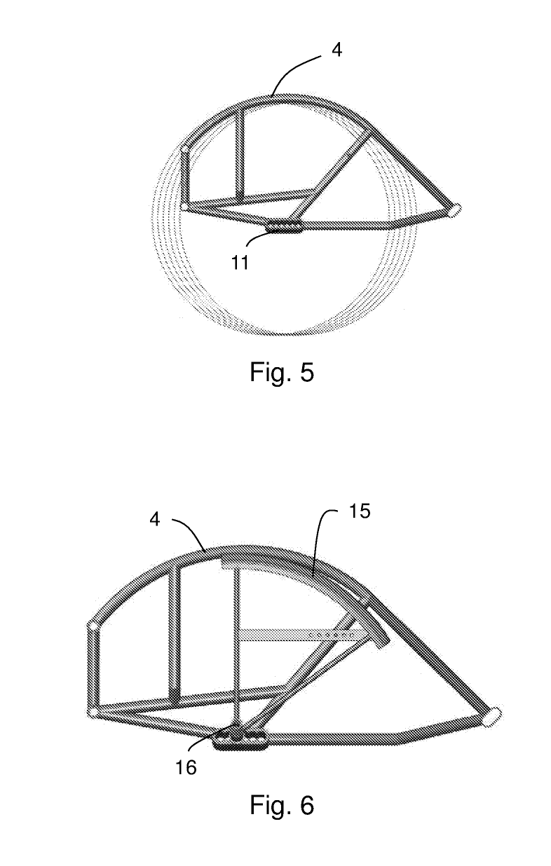

FIG. 5 is side view of the frame pointing out the extreme positions taken by the rear wheels.

FIG. 6 is a first configuration of the wheelhouse.

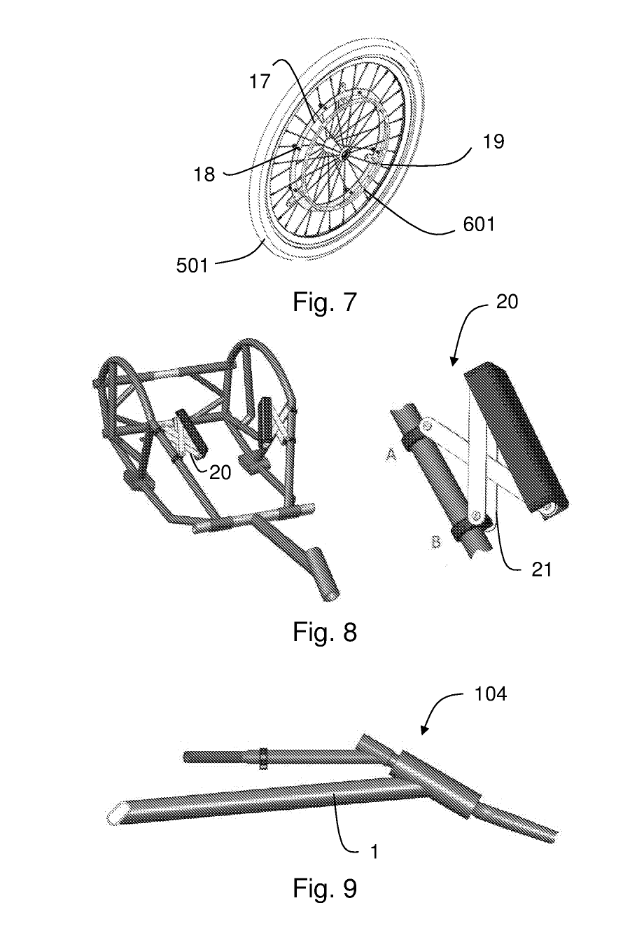

FIG. 7 is a spoke wheel with the plate for attaching the pushrim.

FIG. 8 is the support of the athlete knees mounted on the frame (left) and detail (right).

FIG. 9 is the telescopic steering system.

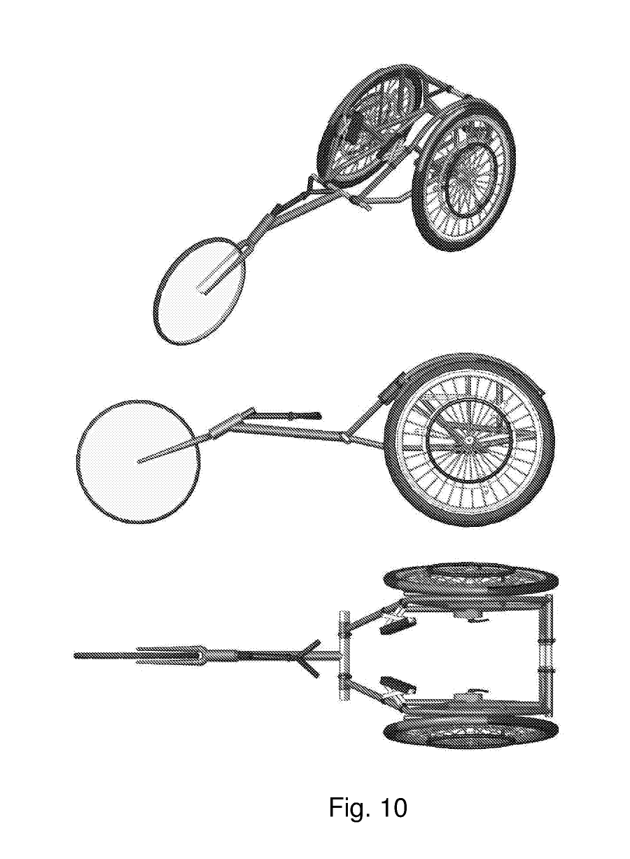

FIG. 10 is an axonometric side and top view of a complete wheelchair according to one embodiment.

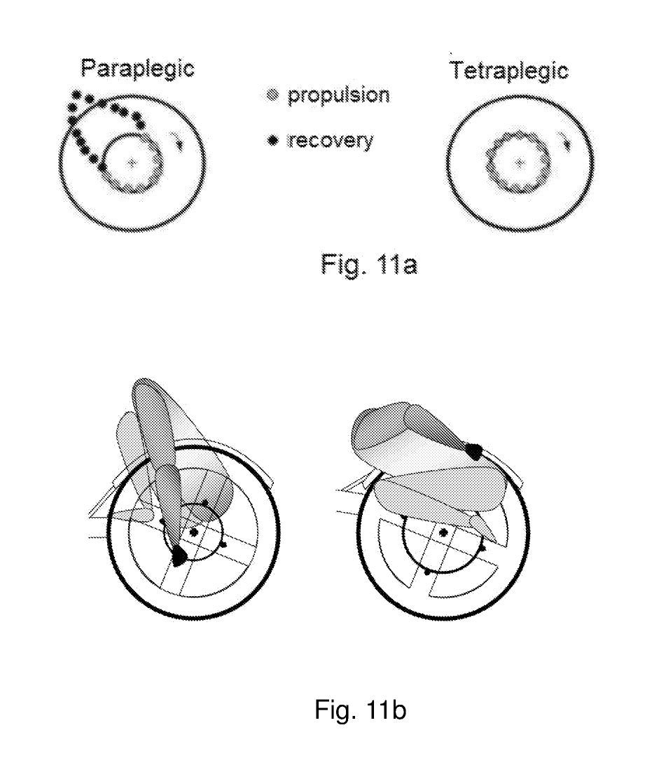

FIG. 11 is a schematic view showing the differences of use of the pushrim between paraplegic and tetraplegic athletes (FIG. 11a) and corresponding positions taken by the wheelchair (FIG. 11b).

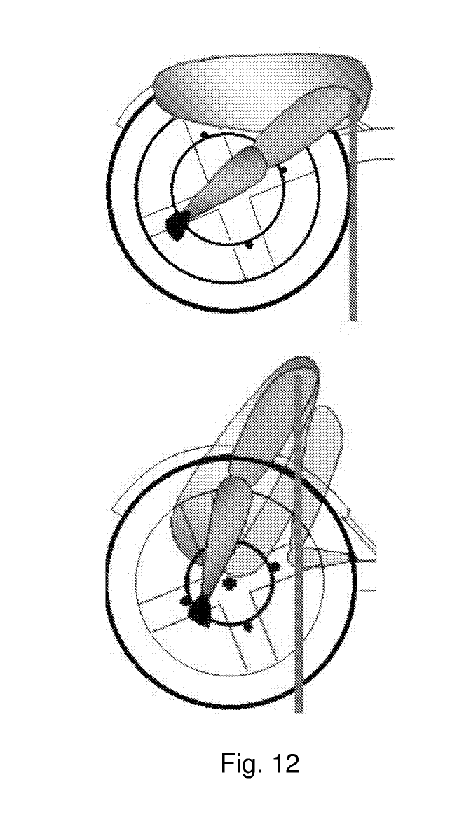

FIG. 12 is the references for an optimal positioning within the wheelchair: paraplegic athlete in the top part and tetraplegic athlete in bottom part.

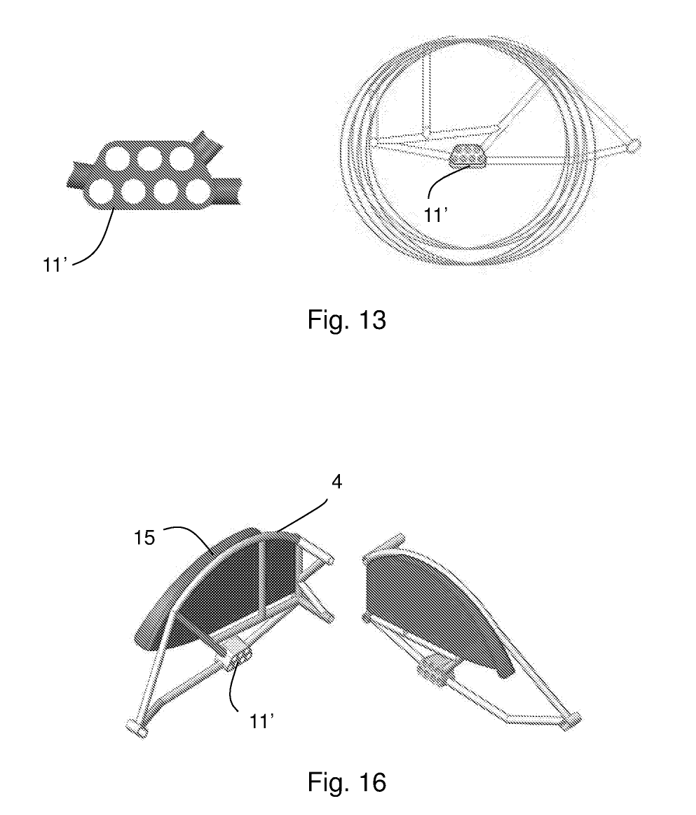

FIG. 13 is a modified version of the attachment of the rear wheel (left) showing the extreme positions taken by rear wheels (right).

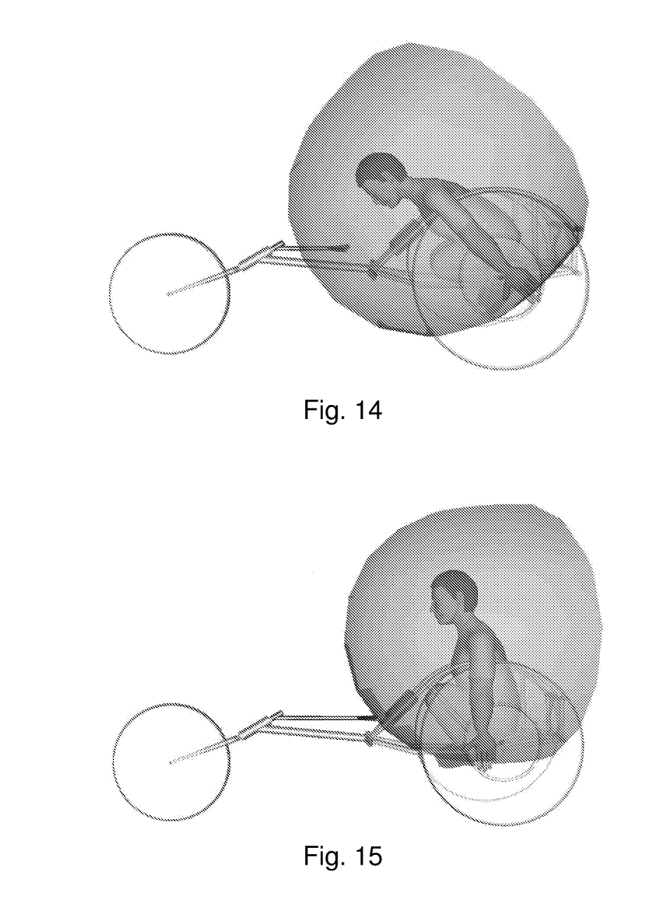

FIG. 14 is the position of a paraplegic athlete 120 cm tall with 24 inch wheels in the forward position.

FIG. 15 is the position of a tetraplegic athlete 120 cm tall with 24 inch wheels in the rearward position.

FIG. 16 is an alternative configuration of the wheelhouse integral to the cage and the corresponding side support.

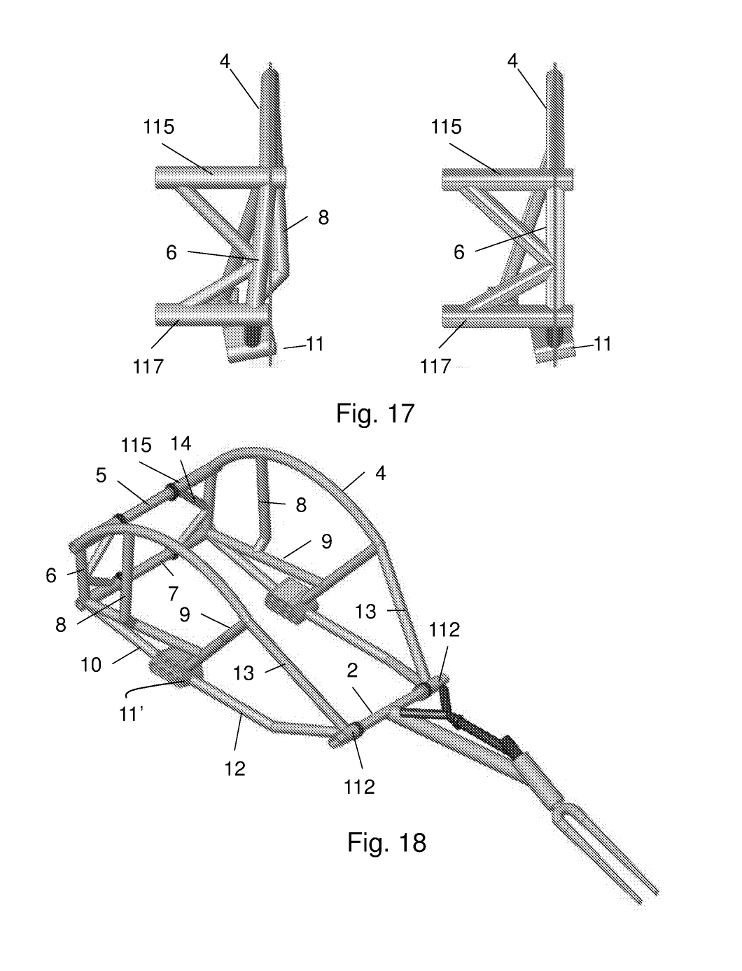

FIG. 17 is a variant wherein the components composing the sides of the frame structure are arranged on a plane (right) with respect to the version with out of plane nodes (left).

FIG. 18 is an axonometric view of the frame of a wheelchair according to another embodiment of the invention.

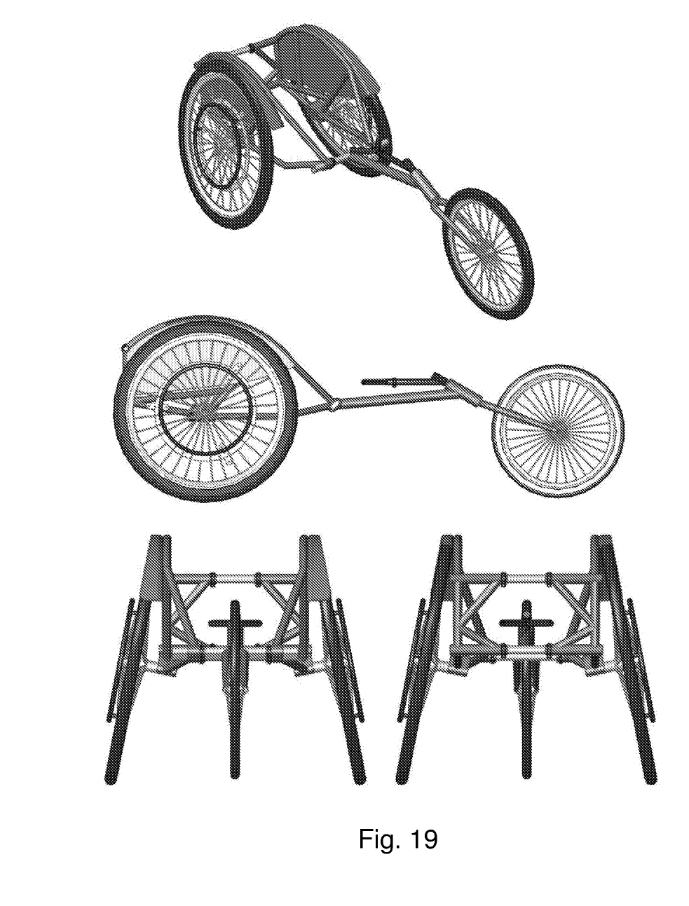

FIG. 19 is an axonometric side, front and rear view of a complete wheelchair with frame as of the previous figure.

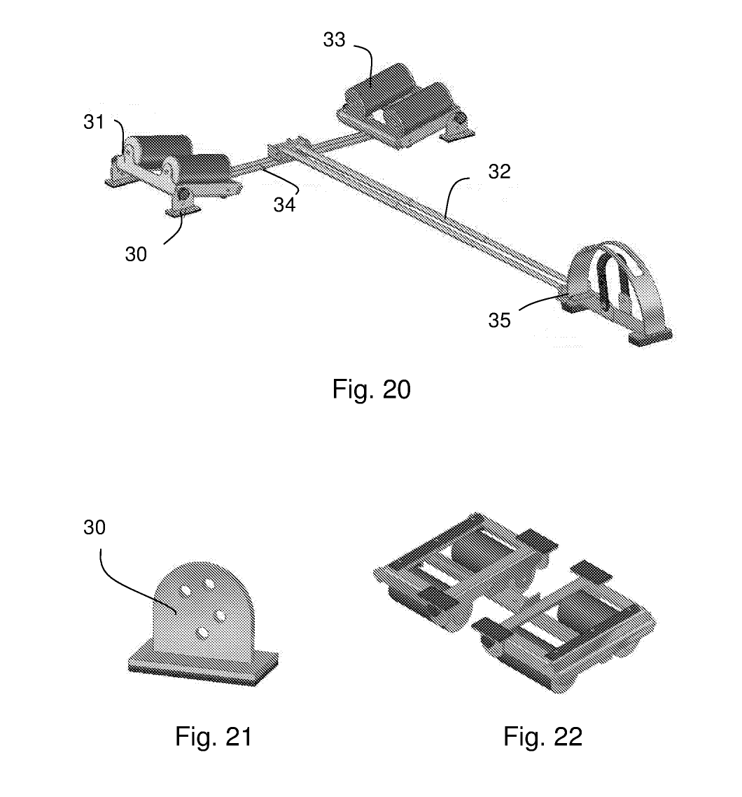

FIG. 20 is a roller device particularly useful for being associated to the wheelchair according to the invention for pre-race warmup and athlete training.

FIG. 21 is a detail of the adjustable foot to change the inclination of the roller supports.

FIG. 22 is the rollers in the configuration for being transported.

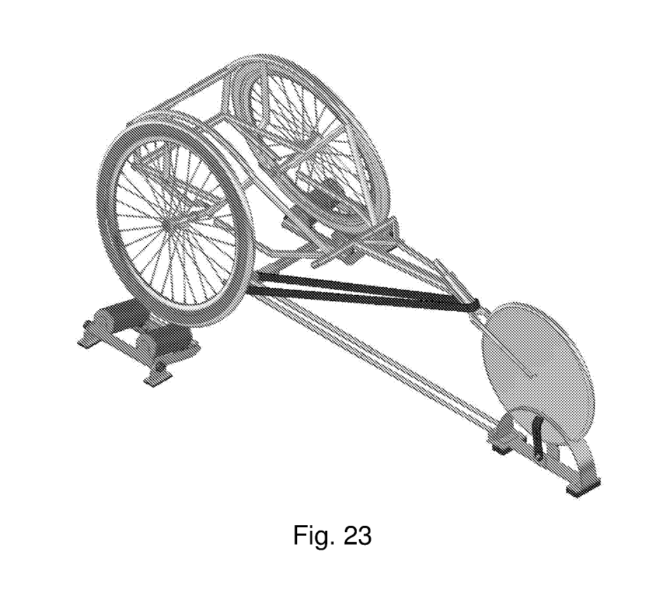

FIG. 23 is the wheelchair according to the invention coupled to the roller device of FIG. 20

Wheelchairs for athletics have a well-established layout with a T shaped frame and a three wheel configuration. However the individual elements are substantially variable as regards geometries and dimensions, due to the need of efficaciously tailoring the wheelchair to the athlete. For this reason the market provides, for competitive uses, mainly wheelchairs customized for the customer. The main elements of the wheelchair are shown in FIG. 1. They can be divided in four macro-groups:

a) Frame;

b) Front wheel, brake and steering system;

c) Rear wheels;

d) Cage and seat.

A brief description of each group is shown below.

Frame

The frame 101 of a wheelchair for athletics generally is composed of a longitudinal body and a transverse body, geometrically T-shaped (or Y shaped) arranged. Aluminium tubes, with circular cross-section or, more often, oval cross-section, are usually used for making it. 6061 T6 aluminium is certainly one of the most common, an aluminium-magnesium-silicon-copper alloy subject to solution treatment, temper and artificial aging. Such alloy is of general-purpose use and it is characterized by not too high mechanical strength, good corrosion resistance, high toughness also at low temperature, optimal weldability, good machinability and poor formability. As an alternative 7005 aluminium is used, an aluminium-zinc-magnesium alloy that does not need artificial aging. The latter combines mechanical properties slightly better than those of 6061 T6 aluminium to a good weldability.

Front Wheel, Brake and Steering

The front wheel 201 and the brake 301 have an arrangement similar to the one used for bicycles. The steering system on the contrary is more characteristic. In the top part it has a handlebar 104 similar, from a conceptual perspective, to the cycling handlebar, being different seemingly only for the more elongated shape, which is necessary for ergonomic reasons. However the control of the steering system, since it requires using hands, obliges the athlete to stop the propulsion. Therefore in case of competitions on racing tracks, where the path is regular and turns have all the same direction, a steering control device is widely used, placed in the lower part of the steering system. It is a lever, controlled by a handle 204, positioned by the athlete (and kept still by a pair of screws) prior to the competition. Its purpose is to give to the steering system the proper angle, such to allow the athlete to handle it with rapid touches if necessary, instead of driving it along the whole trajectory of the turn. This device is called as Track Control Steering Mechanism. The TCSM is connected to the steering system by a spring called compensator 304. This device can be positioned both in the lower part and in the upper part of the frame, with both triangular and rectangular levers-handles.

Rear Wheels

Rear wheels 501 are connected to the frame 101 at the two ends of the cross member. Between such two elements an insert is interposed acting for inclining the wheels by a suitable camber angle. It is adjustable, within a narrow range of values, depending on characteristics of the athlete. The pushrim 601 is further secured to the rear wheels, with a diameter suitable to the characteristics of the athlete. The most common rear wheels are disc wheels made of carbon fiber or four spoke wheels still made of carbon fiber, or metal spoke wheels (almost out of use). As regards pushrims the number of attachments varies from 4 to 28 depending on the type of wheel on which they have to be mounted.

Cage

The cage 107 is welded directly on the frame 101 and it acts for receiving the athlete, allowing him/her to take a proper and optimal position for the propulsion. The deep differences among the different levels of disabilities have led to develop different geometries for the cage such to adapt it not only to the size but also to the position taken by the athlete. Some athletes are still able to use abdominals to support the trunk and therefore can partially extend their legs, while others need to keep their knees high to support the trunk. For the selection of the type of cage the main criterion is the position taken by the athlete, that generally is of the “feet forward” type (FIG. 2a) or “kneeling” type (FIG. 2b), that in turn depends on the type of injury. The seat 207 for the athlete is placed inside the cage. Generally strap bands are used.

The wheelchair according to the invention has the characteristic of being highly modulable and reconfigurable such to receive athletes with different size and different disabilities in a single device achieving results comparable with the very expensive customized solutions as regards tailoring to the athlete conditions. In order to reach such high configuration level it has been necessary to act on the frame structure. FIGS. 3 and 4 show a first embodiment thereof.

Such version provides a front half-frame 1 connecting the fork to the cage. The cage is divided in two halves a) and b) composing the side longitudinal elements of the frame and that are free to move laterally by sliding on three connection rods 2, 5 and 7. The front rod 2 is integral with the half-frame and it acts as a connection of the cage to the latter. Such rod has an oval section such to prevent half-frame and cage to accomplish a relative rotation. At the back there are provided two telescopic rods 5, 7 connecting the two halves of the cage. Such rods are in a backward position to allow the backrest to be moved for properly positioning taller athletes.

With reference to said transverse rods 5, 7 and 2 these are the transverse elements of the frame that allow it to be width adjusted in a progressive and continuous manner or by steps.

Such rods can be implemented in different manners. They can be of the telescopic type, sliding simply in the axial direction, or can be composed of two elements coupled with each other by threaded portions therefore the rotation of one element with respect to the other element or of a central element with respect to two end elements causes also an axial displacement, or they can be composed of two arms provided with longitudinal slots or rows of holes and tightening bolts passing through the slots or two coinciding holes of the two arms and tighten them with each other.

Among the several possible solutions, the shown solution provides the transverse elements of the frame to be composed of tubular segments, such as bushings or sleeves 115, 117 and 112 integral with the respective side, longitudinal part of the frame a) and b) and are oriented with their axes perpendicularly to the longitudinal axis of the wheelchair and are in a position symmetric in a mirror-like manner with each other, while the two transverse bushings 112 and said two transverse tubular segments 115 and 117 are connected to each other by means of transverse rods axially fitting in a sliding manner into said bushings 112 and said transverse tubular segments 115, 117.

Therefore it is clear that a transverse connection rod is fitted by its ends into one of the bushings 112 of the corresponding frame part respectively and also in one of the tubular segments axially coinciding with each other 115, 117 of the corresponding frame part respectively.

By means of this the tubular segments and the bushings are freely slidable along the portion of the rod engaged therebetween.

For removably locking in a relative position each tubular segment or each bushing 112 and the corresponding end part of the transverse rod it is possible to provide different means such as for example radial pegs engaging contemporaneously at least one radial hole in the wall of a tubular segment or of a bushing and a hole or radial notch of an axial row of holes or notches provided on the connection rod 2, 5, 7.

As an alternative to radial pegs it is possible to provide a threaded pin the holes and/or notches being threaded too.

Still according to one alternative, the threaded hole is provided only in the wall of each tubular segment or each bushing 112, 155 117 and a radial tightening pin is screwed therein which is pushed axially against the outer surface of the transverse rod while removably locking it.

A further alternative provides along an end portion at one free head end the tubular segment 115 and 117 and the bushings 112 to have an axial notch whose width allows, by a circumferential compression exerted on the outer surface of said end portion, the inner diameter of said portion of the tubular segment or bushing to be reduced. Thus by means of tube clamps or clamping rings or the like fitted on said end it is possible to clamp the tubular segments and the bushings against the rod therein by locking it as regards a displacement.

The embodiments described above are only possible different examples of different means that allow the frame to be width adjusted and to be locked in the selected width condition.

In the top part of the cage there are provided curved rods 4 suitably shaped such to join the extreme positions taken by the wheel such as shown in FIG. 5. This allows the athlete to reach the pushrim to the greatest extent since the overall dimensions of the frame are reduced.

The seat supporting rods 9 are arranged such to guarantee the proper positioning of the athlete, while the backrest support rods 8 are shaped in a such a manner not to interfere with the user pelvis. At the same manner the shape of the front rods of the cage 12 has been defined such to maximize the space available for the athlete legs. The wheel attachment 11 is provided between the rods 10, 12 and 13 and it has six discrete positions to allow the position of the rear wheels to be longitudinally changed.

Even if it is possible to provide an attachment arranged parallel to the ground with a wheel pin inclined such to select the desired camber angle of the wheels, in this embodiment the attachment is advantageously arranged with an inclination equal to the required camber and the wheel pin is straight.

The frame is completed by the reinforcement oblique rods 14 on the rear attachments of two halves of the cage, that contribute in stiffening the structure, and by wheelhouses 15 shown in FIG. 6.

Although this seems a not important detail, wheelhouses have a considerable importance. They act for preventing the athlete arms during the push action from contacting the tire causing abrasions. Such components have to be lightweight, less cumbersome and able to follow the wheel during the translation.

A solution provides an attachment coaxial with the wheel pin 16 and a screw fastening to the frame to prevent wheelhouses from rotating. This latter, once the locking screw is unscrewed, is released together with the wheel to change the position thereof.

FIG. 16 shows a preferred alternative configuration of the wheelhouse. The version of FIG. 6 in addition to be quite uncomfortable, since it makes it necessary to remove the wheelhouse, together with wheel and pin, in order to place it in the new position, does not allow both 24 inch and 26 inch wheels to be used with the same wheelhouse. Such drawback is overcome by introducing a wheelhouse 15 integral with the cage with a radius of curvature such to allow the wheel to longitudinally translate and both the sizes of the wheel to be used. Moreover by modifying the curvature of the upper rods 4 of the cage and the position of the upper rod connecting the two halves thereof in order to connect them with the wheelhouse it is possible to obtain a more harmonic assembly with a minimum overall size of the frame.

The wheelhouses are completed by two side boards acting for containing the torso and trunk of athletes, particularly for tetraplegic athletes that, since not having the control of abdominal muscles, are not able to autonomously support themselves. Such side boards are made of sheet metal or fiber glass and are joined to the wheelhouses described above. FIG. 16 shows both such components.

As regards the pushrims 601 a system has been developed that allow them to be easily and rapidly replaced also with spoke wheels 501. In order to accomplish the above, a ring-shaped plate 17 has been fitted between the spokes of the wheel, to be inserted before completing the mounting. Such plate is fastened to the wheel spokes by means of eight screws 18 and it allows 280, 320, 360 or 400 mm pushrims to be used, each one secured thereto by means of three screws 19 (FIG. 7). The choice of using a spoked wheel, involving a higher number of attachments for the pushrim, instead of a disc wheel or aero-spoke wheel, derives from the need of reducing costs.

In customized wheelchairs, the shape and dimensions of the frame are suitably selected for supporting and laterally containing the athlete knees. Since the frame according to the invention does not provide per se the support for the knees necessary in case of kneeling position, as it would be in a U-shaped cage, it is necessary to use straps connected to the cage to suitably support the athlete knees if he/she would take such position. However only the straps do not guarantee the necessary lateral support, this is the reason why two supports 20 have been introduced which are adjustable in position and inclination such as shown in FIG. 8. They use a system of rods 21 arranged such to form an articulated quadrilateral, such to change their inclination by simply moving the rings connecting to the frame A, B.

The wheelchair is completed by the steering system 104 shown in FIG. 9, of the telescopic type such that it can suit the needs of the user such to be easily operated also by children.

FIG. 10 shows an overview of the wheelchair described above suitable for receiving athletes with different types of disabilities and anthropometric dimensions.

As already said, the position of the athlete in the cage and the manner the pushrim is used for propelling the means considerably changes depending on the disability.

The International Paralympic Committee (IPC) uses a classification of the athletes based on the position of the spinal injury identifying the vertebra closest thereto. The body parts involved in the disability therefore will be all those parts placed below the injury. Moreover the power of each muscle is measured by measuring by specific tests a performance grade, ranging from 0 to 5. Athletes in a wheelchair due to spinal cord injuries or amputations fall within the T51-T58 classes.

T51-T54 classes are for wheelchair athletes competing in track events, while T55-T58 classes are for athletes competing in field events. An athlete who is classed as T54 is completely functional from the waist up; an athlete who is classed as T53 has restricted movement in abdominals; an athlete classed as either T52 or T51 has restricted movement also in upper limbs.

Athletes who are in a wheelchair due to cerebral palsy have classes different from athletes with a spinal cord injury or amputation, and range from T32 to T38. Classes T32-T34 are classes for athletes in a wheelchair and classes T35-T38 are for athletes who can compete on their own legs.

As regards competitions with reference to the wheelchair according to the invention, reference is essentially made to four classes:

T51

These athletes, for dorsal, elbow and wrist flexion, have a muscle power to grade 5, with a decrease of shoulder muscle and pectoralis power. Triceps muscle power varies from grade 0 to grade 3. They use elbow flexors and wrist dorsiflexors for propulsion. They sit in an upright position with knees under the chin. They have large push rims. Spinal cord injury at level C5-6.

T52

These athletes usually have normal shoulder, elbow and wrist muscle power, but with poor muscle power of the finger flexors and extensors, there being wasting of the muscles of the hands. They use shoulders, elbows and wrists for propulsion. They usually have no trunk function. They use gloving techniques similar to the next two classes. Spinal cord injury at level C7-8.

T53

These athletes have normal arm muscle power but with no abdominal and generally lower spinal muscle activity. They use different techniques to compensate for lack of abdominal musculature such as lying horizontal. In a race their acceleration is slower than the T54 class. In general when great acceleration occurs, the trunk rises off the legs due to a lack of abdominal muscles. They usually have to interrupt the pushing cycle to adjust the compensator. Spinal cord injury at cord level T1-7.

T54

These athletes have normal arm muscle power with a range of trunk muscle power extending from partial trunk control to normal trunk control. Athletes who compete in this group may have significant leg muscle power. These athletes moreover have a sufficient trunk control which allows them to hold their trunk down also in case of great accelerations. Usually they do not interrupt the pushing cycle to adjust the compensator. They can shift direction of the wheelchair by sitting up and applying a trunk rotational force. Spinal cord injury at cord level T8-S4.

More generally the manner the athlete uses the pushrim and therefore his/her position in the cage changes depending on the type of injury. A paraplegic athlete, namely with injury at thoracic vertebrae, having the complete control of arms and trunk, applies a pushing action on the handrail using above all triceps. On the contrary a tetraplegic athlete that is with injuries at cervical vertebrae, since having a limited control of arm muscles, uses above all biceps exerting a pulling action on the handrail without removing hands therefrom (FIG. 10). In addition to using the handrail in a different manner, a paraplegic athlete uses also a pushrim with a diameter greater than that used by a tetraplegic athlete.

On the whole in order to properly position a paraplegic athlete on the wheelchair, it is necessary that when he/she completes the pushing phase having the trunk approximately parallel to the ground, the vertical line passing by the shoulder is tangent to the wheel such as shown in the top part of FIG. 11.

As regards a tetraplegic athlete, that on the contrary does move the trunk during the pushing phase, it is necessary for the vertical line passing by the shoulder to fall more ahead than the tangent to the pushrim as shown in the lower part of FIG. 11.

This requires the maximum flexibility of use of the elements composing the wheelchair, particularly the cage, rear wheels and pushrims.

Inventors have observed that the ability of reaching the pushrim for a paraplegic athlete has improved by moving forward the position of the wheel, while tetraplegic athletes have taken advantage from moving it backwards. Moreover by reducing the diameter of the wheel it is possible to move the pin thereof nearer the user body, therefore moving each point of the pushrim nearer him/her, whose diameter remains constant.

However in order to use the advantage just disclosed it is necessary to have a wheel attachment allowing the pin to be really placed nearer the user body, while allowing also 26 inch wheels to be mounted. To this end the wheel attachment 11 of the first embodiment has been replaced by a new version 11′ having two series of holes at two different heights, such to make it possible to use both 24-inch and 26-inch wheels, allowing both of them to be longitudinally translated (FIG. 13).

This leads to a clear improvement in reaching the pushrim by shorter athletes. Since the diameter of the wheel has been reduced by about 2 inches, that is about 50 mm, they are able to clearly reach a greater portion of the handrail, thus obtaining a clear gain as regards efficacy of the pushing action.

Moreover as already mentioned above the fact of moving the wheel forward is useful in case of paraplegic athletes while the fact of moving it backwards is useful in case of tetraplegic users. Paraplegic athletes, by taking a position with the trunk leant forwards, have an advantage in terms of reachability by moving the wheel forward (FIG. 14), while tetraplegic athletes, by keeping their trunk in an almost vertical position, have an advantage in moving the wheel backwards (FIG. 15).

A further arrangement used in a variant of the frame is shown in FIG. 17. In order to prevent the cage from interfering with the athlete body such to guarantee the greatest comfort, the most immediate solution is a quite complex geometry with many rods out of plane. However the inventors, by means of ergonomics analyses, have checked how such a higher realization complexity is not really necessary.

To this end a variant of the frame has been introduced, basically by bringing on one plane all the rods composing the two halves of the cage, such to rationalize the geometry thereof.

As it can be noted in FIG. 17, the variant of the cage (on the right) has rods arranged on one plane, while the version of the first embodiment (on the left) is developed also out of plane. Such new version, besides being less complicated to be implemented, reduces also efforts since out-of-plane nodes introduce bad torques stressing the structure to a greater extent.

FIG. 18 shows an overview of the frame with not coplanar side rods and with wheel attachments with two rows of holes according to the variants described above. Obviously each variant can exist independently from each other.

FIG. 19 shows an overview of the wheelchair described above.

FIGS. 20 to 23 show a roller device particularly useful for being used in combination with the wheelchair of the present invention.

The roller device is used both for pre-race warmup and for training when it is not possible to use the racing track. It is a metal structure supporting two or more rollers and that supports the wheelchair.

On the market there are different roller types, but no one of them is designed for being easily transported. Therefore the athletes, which need warming up before the competition and cannot occupy the track, are obliged to use rollers that are handcrafted such to be less cumbersome and easy to be transported.

Such handcrafted solutions are suitably made for trainers and athletes based on their needs, therefore can be different as regards configuration, shape and materials.

Most of the handcrafted solutions have two rollers for each rear wheel, a foldable structure made of lightweight alloy and a support for the front wheel, connected or not to the remaining part of the structure.

This essentially has the following problems:
great weight (about 11 kg) due to the use of solid section bars and excessive thicknesses.
not usable for wheelchairs with very large or very small contact patch.
do not allow the wheelchair to be retained preventing it from getting off the rollers when the athlete acts on the pushrims in a powerful manner.
do not allow a braking action to be performed on the wheels to produce different operating conditions.

From the above it results the idea of redesigning the device with the following characteristics:
limited weight and overall size to facilitate its transportation.
possibility of changing the inclination of the rollers depending on the camber angle of the wheelchair wheels such to guarantee it to be better contained.
possibility of adapting the width thereof depending on the contact patch of the different wheelchairs.
ability of retaining the wheelchair to prevent it from getting off the rollers during the push phase.
low manufacturing cost.

The solution shown in FIG. 20 meets such needs. The support 31 of each pair of rollers 33 is hinged to the opposite ends of a telescopic central rod 34 to which the front wheel support 35 is connected through a pair of telescopic rods 32. The inclination of the rollers is obtained by a pair of adjustable feet 30.

The use of a double hinge allows the structure to be broken into three parts such to reduce its overall size once it is folded. Moreover the number of elements is reduced by making the roller support 31 as self-bearing such that it has not to be supported by another frame. Thus two independent sub-assemblies are obtained connected simply by a rod keeping them in place during the use.

Moreover the fact of using two hinges instead of only hinge, placed at the center of the structure, allows the same inclination of the rollers 33 to be obtained even if using a considerably shorter foot 30. This resulting in advantages for the stability.

The choice of the system by means of which adjusting the inclination of the rollers has been particularly hard, since many solutions have been considered some of them being continuous (screw, wedge, caliper) and other discrete ones (holes plus pin, stand).

Finally the system of holes with the pin has been selected since it allows the roller inclination to be quickly and easily adjusted, the overall dimensions to be restricted and it allows the structure to have a good stability. Moreover the adjustment practicality guaranteed by a discrete system, such as the one with holes, prevails over the possibility of a continuous adjustment, such as the one that can be obtained by a screw. Then the necessary inclination angles have been defined, namely 0°-5°-10°-12.5° and the position of the holes of the foot has been defined on the basis thereof.

It has to be noted that giving a specific inclination to the rollers serves for guaranteeing the wheelchair to be laterally contained preventing the pushing action made by the athlete from laterally deviating it.

In order to combine the complete foldability of the roller support on the central rod and the operating stability, even in case of rough ground, instead of a simple hinge an oval section tube has been used, welded on the central rod, inside which a pin is provided connected to the roller support. This guarantees the structure to be adapted to the ground underneath. The presence of a given clearance between the pins, integral to the roller support, and the oval tubes, integral to the central rod in turn connected to the front wheel holder, allows the structure to be rested also on a non-perfectly flat ground, such as a meadow, without stressing the connections.

FIG. 21 shows the rollers ready for being transported.

Make reference now to the front part of the structure. It is composed of two telescopic rods 32 and of the front wheel holder 35. The latter serves to lay the wheelchair flat, bringing the front wheel at the level of the rear wheels, and to keep the front wheel still such to prevent the wheelchair from getting off the roller, due to pushing actions of the athlete. Therefore it is necessary to keep the front wheel holder in position. Rods act for such purpose, by connecting the front support to the rear part, such to avoid it from moving during the training. The choice of using telescopic rods is due to the need of adapting the rollers to wheelchairs with different wheel bases and to limit their overall dimensions during the transportation. Instead of suitably producing the rods the choice has been to use walking poles, available on the market, since they well suit the above mentioned functions and allow costs to be limited.

Such solution uses to the same idea at the base of bicycle holders present in cities, namely to use a slot to hold the front wheel. In this case a sheet metal has been used folded like a semicircle and cut in the middle, connected to a flat sheet metal, acting as a base by means of screws.

The curved sheet metal acts both for holding the front wheel and for bringing it to the same height as the rear wheels, keeping the wheelchair lying flat. Screws have been used instead of welding due to cheapness reasons, the easiness in producing it and reliability reasons.

Moreover an elastic band has been used connected to the wheel resting base, whose function is to make sure that the wheel does not move even if the athlete pushes the pushrims in a particularly powerful manner.

To this end two belts have been further introduced that connect the fork of the wheelchair to the attachment of the telescopic rods on the rear part of the rollers (FIG. 23). Such belts are necessary only during the most intense phases of the warmup, or training, when the athlete exerts the maximum force on the wheels. Under such circumstances they guarantee the wheelchair not to get off the rollers. Therefore they have to be considered as additional components to be used under particular operating conditions and not as components of normal use.

In order to tighten the elastic band and to stretch the belts, and in order to place the wheelchair on the rollers and to adjust the brakes, the athlete needs the help of another person. Such aspect is not a problem since the athlete is helped by the trainer on the competition field.

The device has been mainly designed for being used with a modulable wheelchair according to the invention such as shown in FIG. 23. However it is clear how the same device can be used also with different wheelchairs, both of the customized type and of the type available in sizes, such as those described hereinbefore.

The invention claimed is:

1. A modulable sports wheelchair comprising:
a supporting frame (101);
a front wheel (201);
a pair of rear wheels (501); and
a sitting cage (107),
wherein the supporting frame is divided into a front half-frame (1) connecting a support for the front wheel (201) with a frame structure carrying the rear wheels (501),
wherein the frame structure comprises two facing side longitudinal elements (3, 4, 10, 12) oriented in a movement direction of the wheelchair and a plurality of transverse connection rods, the plurality of transverse connection rods comprising a front connection rod and a rear connection rod (2, 5, 7) for connecting the two facing side longitudinal elements of the frame structure,
wherein the plurality of transverse connection rods are spaced from each other in a longitudinal direction of the wheelchair and are oriented in a direction transversal to a longitudinal axis thereof, the frame structure forming the sitting cage (107),
wherein the sitting cage is configured as a compartment free from internal structural elements, there being provided at least one support element extending transverse to the longitudinal axis of the wheelchair, the at least one support element being supported at each of its two ends by one of the two facing side longitudinal elements of the frame structure,
wherein the at least one support element is movable in the longitudinal direction so as to allow a user to be supported in an optimal position with an optimal posture for propelling the wheelchair depending on a level and type of disability of the user.

2. The modulable sports wheelchair according to claim 1, wherein the side longitudinal elements of the frame structure are free to translate continuously or by steps in a direction moving them away and near each other and are removably lockable with respect to each other, said side longitudinal elements of the frame structure being slidable on at least one (2) of the connection rods, or at least one (5, 7) of the connection rods being extendable and shortenable such to allow a width of the cage to be progressively changed depending on a size of the user, the front half-frame (1) being connected to at least one of the connection rods.

3. The modulable sports wheelchair according to claim 1, wherein the longitudinal sides of the frame structure comprise a fastening element (11, 11′) equipped with a plurality of holes arranged according to at least two directions such to allow the rear wheels (501) to be removably mounted at a variable distance, both along a direction of the longitudinal sides and along height direction.

4. The modulable sports wheelchair according to claim 1, wherein on the rear wheels (501), pushrims (601) are mounted on which the user acts for moving the wheelchair, said pushrims being interchangeable to allow the wheelchair to be equipped with rims of different dimensions.

5. The modulable sports wheelchair according to claim 4, wherein the rear wheels (501) are spoked, the pushrims (601) being mounted on plates (17) inserted between spokes of the rear wheels and fastened thereto by fasteners (18) to reduce attachment points (19) of the pushrims (601) for mounting/removing the pushrims more easily.

6. The modulable sports wheelchair according to claim 4, wherein the cage has a frame composed of longitudinal elements, vertical elements and transverse elements in combination with one or more supports for supporting the athlete user, the one or more supports being which are removably fastenable to said frame of said cage, and wherein said longitudinal elements, vertical elements and transverse elements contemporaneously allow:
a paraplegic athlete to take a position kneeling in the cage with his or her trunk leant forwards, the pushrims and the rear wheels having a size, shape and position with respect to the cage such that a vertical line passing by a shoulder of the paraplegic athlete with the trunk parallel to the ground and an arm lying on the pushrim is tangent to a corresponding wheel, and
a tetraplegic athlete to take a position sitting in the cage with his or her feet forwards, the pushrims and the rear wheels having the size, shape and position with respect to the cage such that the vertical line passing by the shoulder of the athlete has always a distance from a center of a respective pushrim greater than a radius thereof.

7. The modulable sports wheelchair according to claim 1, wherein the cage comprises a backrest supported by straps adjustably fastenable at opposite sides of the frame structure for moving a seat of the user forward or backward without acting on a structure of the cage.

8. The modulable sports wheelchair according to claim 1, wherein the longitudinal sides of the frame structure comprise curved rods (4) shaped to join extreme positions taken by the rear wheels, said curved rods following a profile of wheelhouses (15) to prevent the user from interfering with a wheel tread.

9. The modulable sports wheelchair according to claim 1, wherein the side longitudinal elements of the frame structure comprise support rods (9) for a seat and support rods (8) for a backrest.

10. The modulable sports wheelchair according to claim 1, wherein the transverse connection rods composing the side longitudinal elements of the frame structure are coplanar.

11. The modulable sports wheelchair according to claim 1, further comprising a pair of adjustable supports (20), adjustable in position and inclination for laterally containing knees of the user, said supports being mounted on the frame structure with ring fasteners (A, B).

12. The modulable sports wheelchair according to claim 11, wherein the adjustable supports (20) comprise a system of rods (21) arranged to form an articulated quadrilateral and to allow an inclination of the adjustable supports to be changed by modifying a mutual position of the ring fasteners (A, B).

13. The modulable sports wheelchair according to claim 1, wherein that the frame structure comprises two longitudinal side structures having rods that form trusses connected by at least a pair of transverse connection rods, one of the transverse connection rods, with elliptical section, being connected to the front half-frame (1) bearing the front wheel (201).
